(19) United States
(12) Patent Application Publication
(10) Pub. No.: US 2014/0137735 A1
(43) Pub. Date: May 22, 2014

(54) POLYIMIDE MEMBRANES AND METHOD OF PRODUCTION

(71) Applicant: GENERAL ELECTRIC COMPANY, Schenectady, NY (US)

(72) Inventors: Dhaval Ajit Bhandari, Niskayuna, NY (US); Kristi Jean Narang, Niskayuna, NY (US); Kimberly Ann Polishchuk, Niskayuna, NY (US)

(73) Assignee: GENERAL ELECTRIC COMPANY, Schenectady, NY (US)

(21) Appl. No.: 13/730,498

(22) Filed: Dec. 28, 2012

Related U.S. Application Data
(60) Provisional application No. 61/728,419, filed on Nov. 20, 2012.

(51) Int. Cl. B01D 71/64; B01D 69/08; B01D 53/22; B01D 67/00

(52) U.S. Cl. CPC B01D 71/64; B01D 67/0093; B01D 69/087; B01D 53/228
USPC 95/47; 95/45; 95/51; 96/10; 264/6; 95/55; 95/52; 95/50; 95/54; 95/49

(57) ABSTRACT

The disclosure relates generally to a gas separation membrane and a gas separation method in which at least one type of gas is separated and recovered from a gas mixture, using the gas separation membrane. The gas separation membrane is asymmetric and hollow and made of a polyimide material. The method of the invention provides a practical, high-performance technique for gas separation.

### CROSS-REFERENCE TO RELATED APPLICATIONS

This application claims the benefit under 35 U.S.C. §119 of U.S. Provisional Patent Application No. 61/728,419, filed Nov. 20, 2012, the entire disclosure of which is incorporated herein by reference.

### STATEMENT REGARDING FEDERALLY SPONSORED RESEARCH & DEVELOPMENT

This invention was made with Government support under contract number DE-AC07-05ID14517, awarded by The Department of Energy. The Government has certain rights in the invention.

### BACKGROUND

The state of the art of polymer membrane-based gas separation processes has evolved since the 1980s. Membrane-based technologies have advantages of both low capital cost and high-energy efficiency compared to conventional separation methods. Membrane gas separation is of special interest to petroleum producers and refiners, chemical companies, and industrial gas suppliers. Several applications have achieved commercial success, including carbon dioxide removal from natural gas and from biogas and enhanced oil recovery, and also in hydrogen removal from nitrogen, methane, and argon in ammonia purge gas streams. For example, UOP's Separex® cellulose acetate polymeric membrane is currently an international market leader for carbon dioxide removal from natural gas. Although cellulose acetate membranes have many advantages, they are limited in a number of properties including selectivity, permeability, and in chemical, thermal, and mechanical stability.

As well as the oil industry, there are a variety of applications that depend on the ability to separate one gas from another, including chemical manufacturing, H₂ purification for fuel and carbon dioxide capture and sequestration. Membrane technologies have the potential to improve process efficiency and reduce the cost when compared to conventional technologies, such as pressure swing absorption or cryogenic distillation systems. While membrane systems have been commercially available for decades, further development is needed to increase separation performance, reduce costs, tackle scalability issues and adapt performance to process conditions. Thus, there is a need in the art for new and improved membranes for separating gases from one another.

### SUMMARY

The present invention discloses novel polyimide membranes and methods for making and using the same. The polyimide hollow fiber membrane of the present disclosure utilizes a chemically and thermal robust polymeric material, and is easy to fabricate with also lower production costs compared to other membrane based platforms.

Applicants herein disclose asymmetric hollow fiber membranes, and the application of such membranes for high temperature gas separations. The asymmetric hollow fibers are fabricated by a unique one-step extrusion technique that does not require multiple processing steps, for example, in composite coated membranes. Furthermore, the fibers are easily scalable with >50-60 m/min production rates. Hollow fibers provide a high surface area to unit volume compared to other membrane platforms such as plate in frame or spiral wound membranes. The polyimide material, for example, is stable at high temperatures (200-400° C.) and under stringent syn-gas conditions (e.g., H₂S, CO, Steam).

One aspect of the present disclosure is directed to a membrane for gas separation, comprising asymmetric hollow polyimide fibers derived from a precursor composition comprising polyamic acid and an additive, wherein said membrane is a heat resistant membrane and is operable up to about 350° C. Another aspect of the present disclosure is directed to a method for the production of an asymmetric hollow fiber membrane comprising: preparing a dope solution comprising a poly(amic acid), a non-solvent, and one or more of solvents selected from the group consisting of n-methyl-2-pyrrolidone (NMP), N,N-dimethylacetamide, and N,N-dimethylformamide, and tetrahydro furan; dissolving an additive in said dope solution to form a viscous dope mixture; and spinning said dope mixture to form a polyimide-based asymmetric hollow fiber membrane. In one embodiment, the one or more solvents may be chosen from a larger group of solvents, examples of which are provided below.

The membrane is operable, for example, from about 20 to about 350° C. In one example, the membrane is operable up to about 200° C. In a particular embodiment, the membrane is capable of separating hot gases or vapors, where the temperature is about 30, about 60, about 100, about 150, about 200, about 250, about 300, about 350, or about 400° C. In a particular embodiment, the membrane is capable of separating hot gases or vapors, where the temperature is from about 150 degrees to 350° C. In another embodiment, in addition to being heat resistant, the membrane is also resistant to chemical degradation, such that the membrane is resistant to changes in its structure and membrane function as a result of treatment with mercury, steam, hydrogen sulfide, carbon monoxide, fly-ash, SOx, NOx, acid gases.

In one embodiment, the polyimide used in various embodiments of this invention can be of various types, such as polyethermides. Moreover, polyimide copolymers (e.g., polyamide-imides) or physical mixtures (blends) of polyimides with other polymers may sometimes be used. In one embodiment, the polyimide constitutes greater than about 50% by weight of any blend.

In one embodiment, the asymmetric hollow fiber membrane comprises a polymer which is selected from a group consisting of aromatic polyamides, aliphatic polyamides, polyetherimides, polyethersulfones, polyetheresters, polysulfones, polyvinylidene fluoride, polybenzimidazoles, polybenzoxazoles, polyacrylonitrile, polyazoaroaromatics, polyamide imides, polyamide esters, polyimides, polyesters, and blends thereof, copolymers thereof, and substituted polymers thereof. In one embodiment, an additive is used in conjunction with the polyamic acid. In one embodiment, the additive is a material capable of increasing the hydrophilic character of the polyimide fibers. In one embodiment, the additive is selected from a group consisting of polyvinylpyrrolidone, polyetheretherketones, lithium nitrate, poly(ethylene glycol) (PEG), lithium chloride (LiCl), acetic acid, phosphoric acid, and propionic acid.

In one embodiment, the membrane of the presently taught disclosure further comprises one or more solvents, or a mixture thereof, selected from the group consisting of phenol, cresol, xylenol, catechol, 3-chlorophenol, 4-chlorophenol, 4-bromophenol, 2-chloro5-hydroxytoluene, N-methyl2-pyrrolidone, N,N-dimethylformamide, N,N-diethylformamide, N,N-dimethylacetamide or N,N-diethylacetamide, tetrahydro furan, dimethylsulfoxide, C1-C6 alcohols, toluene, methylene chloride, and acetone.

In one embodiment, the precursor composition comprises about 5 to 50 weight percent solution of poly(amic acid) in a solvent. In another embodiment, the polyamic acid is obtained by reacting a dianhydride monomer with a diamine monomer. In an additional embodiment, the composition further comprises n-methyl-2-pyrrolidone (NMP). In one embodiment, the dianhydride monomer is (diphenyltetracarboxylic dianhydride (ODPA) and the diamine monomer is oxy-dianiline (ODA)). In one embodiment, the polyimide is obtained by curing a polyamic acid, and wherein the said polyamic acid is obtained by reacting a dianhydride monomer with a diamine monomer.

In one embodiment, the membrane exhibits gas separation performance in which the permselectivity for hydrogen/carbon dioxide is from about 5 to 10, the hydrogen/carbon monoxide permselectivity is from about 30 to 60, the permselectivity for water/hydrogen is from about 5 to 10, and a carbon dioxide/methane permselectivity is from about 5 to 20. The membrane is used, for example, for hydrogen purifications at high temperatures of from about room temperature to about 350° C. In one embodiment, the hollow asymmetric membrane is made from a one step extrusion of a polyamic acid spinning solution comprising polyamic acid, solvent, non-solvent, and an additive.

In one embodiment, the non-solvent use in the teachings of the present disclosure is selected from the group consisting of water, methanol, ethanol, n-propanol, isopropanol, acetone, ethylene glycol, glycerol, priopionic acid, methyl ethyl ketone, diethyl ketone, ethyl propyl ketone, or mixtures thereof. In a particular example, the additive is polyvinylpyrrolidone and the non-solvent is water or ethanol.

In one embodiment, the solvent for the preparation of the dope solution comprises one or more solvents, or a mixture thereof, selected from the group consisting of phenol, cresol, xylenol, catechol, 3-chlorophenol, 4-chlorophenol, 4-bromophenol, 2-chloro5-hydroxytoluene, N-methyl2-pyrrolidone, N,N-dimethylformamide, N,N-diethylformamide, N,N-dimethylacetamide or N,N-diethylacetamide, tetrahydro furan, dimethylsulfoxide, C1-C6 alcohols, toluene, methylene chloride, and acetone.

In one embodiment, after the spin dope is mixed with the additive, the spin dope is heated to no more than about 80° C. to achieve the desired dope uniformity and additive dissolution.

In one embodiment, the presently disclosed method further comprises an extrusion step wherein a coagulation liquid into which the dope solution is extruded during membrane formation is selected from the group consisting of water, and an aqueous solution of ethanol, methanol, hexane, C1-C6 hydrocarbons, glycol, glycerol, acetic acid, propionic acid and mixture thereof.

In one embodiment, the method further comprises subjecting the dope mixture to a solvent exchange step, followed by imidizing or curing. In one embodiment, the curing environment comprises nitrogen, air, oxygen, vacuum, and/or enriched nitrogen, vacuum, or inert environment (Argon, Helium etc.). In one embodiment, the curing is performed in the presence of nitrogen. In one embodiment, the thermal treatment protocol includes room temperature to about 250° C. The thermal hold time is from 1 second to 100 hours. In one embodiment, the heating rate is between 0.1 C./min to 10 C./min. In another embodiment, the flow rate of nitrogen or exchange rate in the oven is from about 1 to about 1000 mL/min. In another embodiment, the exchange rate is from about 1 to about 100 per minute. In another embodiment, the degree of imidization is between 10-100%. In one embodiment, during the curing step, the polyamic acid hollow fiber becomes a polyimide. In another embodiment, by spinning the dope mixture into a fiber, a polyamic acid based asymmetric hollow fiber membrane is achieved.

One aspect of the present disclosure is directed to a method of selectively separating and recovering at least one kind of gas from a mixed gas or vapor, comprising feeding the mixed gas or vapor to a feed side of a gas separation membrane comprising an asymmetric hollow membrane made as according to the presently disclosed method, and selectively passing the at least one kind of gas or vapor of the mixed gas or vapor through the gas separation membrane to a permeate side of the gas separation membrane. Another aspect of the present disclosure is directed to a method for selectively separating and recovering a particular gas from a mixed gas containing two or more gases or vapors, where the method comprises passing said gas or vapor through a membrane made by the process as described above.

Yet another aspect of the present disclosure is a method of selectively separating and recovering at least one kind of gas from a mixed gas or vapor, comprising feeding the mixed gas or vapor to a feed side of a gas separation membrane comprising the asymmetric hollow membrane made as outlined in claim 1, and selectively passing the at least one kind of gas or vapor of the mixed gas or vapor through the gas separation membrane to a permeate side of the gas separation membrane.

In one embodiment, the membrane is used in high purity hydrogen production, carbon capture, chemical manufacturing, power generation, refinery application, Fischer Tropsch liquids, fuel cell applications, and water/organic separations. In another embodiment, the membrane is used to separate a variety of gases or vapors, including hydrogen gas, steam, carbon dioxide, oxygen gas, nitrogen gas, methane, C1-C4 hydrocarbons, heavier hydrocarbons, carbon monoxide, hydrogen sulfide and hot mixed gases or vapors that contain organic compound.

One aspect of the present disclosure is directed to a method for selectively separating and recovering a particular gas from a mixed gas containing two or more gases or vapors, said where the method comprises passing said gas through a membrane comprising asymmetric hollow polyimide fibers derived from a precursor composition comprising polyamic acid and an additive. In one embodiment, the method is carried out at a temperature in the range of about 150° C. to about 350° C.

These and other aspects, features, and advantages of this disclosure will become apparent from the following detailed description of the various aspects of the disclosure taken in conjunction with the accompanying drawings.

### BRIEF DESCRIPTION OF THE FIGURES

The subject matter, which is regarded as the invention, is particularly pointed out and distinctly claimed in the claims at the conclusion of the specification. The foregoing and other features and advantages of the disclosure will be readily understood from the following detailed description of aspects of the invention taken in conjunction with the accompanying drawings in which:

FIG. 1 shows, left to right, (a) Cross-section SEM image of the as-spun Example 1 hollow fibers (b) Horizontal SEM image of the as-spun Example 1 hollow fiber membranes.

FIG. 2 shows viscosity measurements of Example 2 spin dopes.

FIG. 3 shows cross-section SEM image of undesired hollow fiber morphology caused by high viscosity spin dope fluid leading to nozzle misalignment.

FIG. 4 shows cross-section SEM image of Example 2 polyamic acid hollow fiber membrane. The fibers were found to have a nice open cell uniform morphology with a thin-selective skin layer. Macrovoids were eliminated by carefully tuning the fiber morphology.

FIG. 5 shows cross section optical image of the hollow fibers from the same spin state formed with a non-concentric bore possibly due to nozzle bore needle misalignment (i.e. spun under identical conditions).

FIG. 6 shows “Baseline” TGA profile for poly(amic acid) hollow fibers.

FIGS. 7A and 7B show detailed sections of the TGA profile shown in FIG. 6, where the left graph shows the evaporation of phyisorbed molecules and the right graph shows the water loss associated with the imidization reaction.

FIG. 8 shows first derivative of the weight loss in the “Baseline” TGA run with respect to temperature.

FIG. 9 shows first derivative of the weight loss in the “Baseline” TGA run with respect to time.

FIG. 10 shows “Short Run” TGA profile for poly(amic acid) hollow fibers.

FIG. 11 shows “Low Flow” TGA profile for poly(amic acid) hollow fibers.

FIG. 12 shows the oven used for curing polyimide hollow fibers. Close-up of quartz tray shown in detail.

FIG. 13 shows permeance increase with temperature for hollow fiber modules potted with Cotronics 4525-IP epoxy: (a) carbon dioxide, (b) hydrogen.

FIG. 14 shows H₂/CO₂ selectivity performance.

FIG. 15 shows gas-separation performance and stability over time.

FIG. 16 shows H₂/CO₂ selectivity performance.

FIG. 17 shows gas-separation performance and stability over time.

### DETAILED DESCRIPTION

Membranes must satisfy the requirements of superior thermal, chemical and mechanical stability, high permeability and high selectivity so that they can be commercialized and applied to a variety of industries. Gas separation processes with membranes have undergone a major evolution since the introduction of the first membrane-based industrial hydrogen separation process in the early 90s. The gas transport properties of many glassy and rubbery polymers have been measured as part of the search for materials with high permeability and high selectivity for potential use as gas separation membranes. Unfortunately, an important limitation in the development of new membranes for gas separation applications is a well-known trade-off between permeability and selectivity of polymers. Despite concentrated efforts to tailor polymer structure to improve the separation properties of polymer membranes, there is still room for new and improved membrane materials that have better productivity and selectivity. The term “permeability” used herein is defined as a rate at which a substance permeates through a membrane. The term “selectivity” used herein is defined as a permeation ratio between two different gas components.

The present invention is directed to an asymmetric gas separation membrane made of a polyimide polymer material exhibiting excellent gas separation performance with a high degree of chemical stability and mechanical robustness and improved mechanical properties. The present disclosure relates to asymmetric hollow fiber membranes, and the application of such membranes for high temperature gas separations. For example, the disclosure is a method for gas separation using the asymmetric gas separation membrane of the present disclosure. Asymmetric hollow fiber membranes of the present disclosure and the method for their fabrication are new and non-obvious.

The fibers were fabricated by a one-step extrusion technique, which has at least the advantage of excluding multiple processing steps, for example, in composite coated membranes. Furthermore, the fibers are easily scalable with >50 m/min production rates. Hollow fibers provide a very high surface area to unit volume compared to other membrane platforms such as plate in frame or spiral wound membranes. In one example, the polyimide polymer material ((diphenyl tetracarboxylic dianhydride (ODPA)/oxy-dianiline (ODA)) is stable at high temperatures (200-400° C.) and under stringent syn-gas conditions (e.g., H₂S, CO, Steam) and provides desirable gas separation properties.

The membranes as disclosed herein provide for significantly lower fabrication costs compared to coated composite membranes. Moreover, for example, the presently disclosed membranes can be used to separate gases or vapors comprising hydrogen and these hydrogen membranes significantly reduce capital and operational expenses of certain businesses by providing high purity hydrogen separations. The membranes of the present disclosure are also highly robust and due to their gas separation properties, they could be used for other applications such as sour gas treatment. In one example, the asymmetric hollow fiber membrane according to the present invention can be used, for example, for gas separation. It is particularly useful in the fields, such as for example, hydrogen gas production, carbon dioxide separation and recovery, spent gas separation and recovery, natural gas separation, gas dehumidification, alcohol dehydration, and oxygen gas production from air.

Because the gas separation membrane comprising the polyamic acid asymmetric hollow membrane of the present disclosure is a practical high-performance gas separation membrane having excellent gas permeation characteristics and excellent mechanical strength as described herein, it is useful for separation between hydrogen gas and a hydrocarbon gas such as methane, separation between hydrogen and nitrogen, separation between helium and nitrogen, separation between carbonic acid gas and a hydrocarbon gas such as methane, and separation between oxygen and nitrogen, and so forth. Amongst other things, the gas separation membrane of the invention is well suited for separation between hydrogen gas and a hydrocarbon gas such as methane, separation between hydrogen gas and nitrogen gas, and separation between oxygen gas and nitrogen gas.

Polyimide based membranes are used for gas and liquid based separation applications due to their chemical, physical and thermal robustness. Polyimide is a gas separation membrane material with heat-resisting and anti-chemical properties due to its high glass transition point and rigid molecular chain structure. Polyimide membranes for gas phase separation are used in commercial applications such as the production of oxygen enriched air, the separation of carbon dioxide from methane and the separation of hydrogen from hydrocarbons.

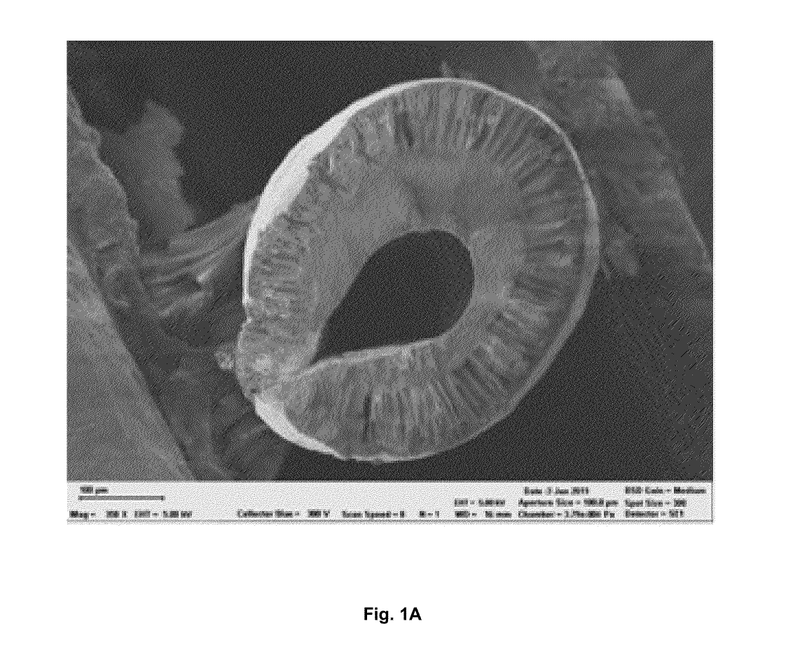

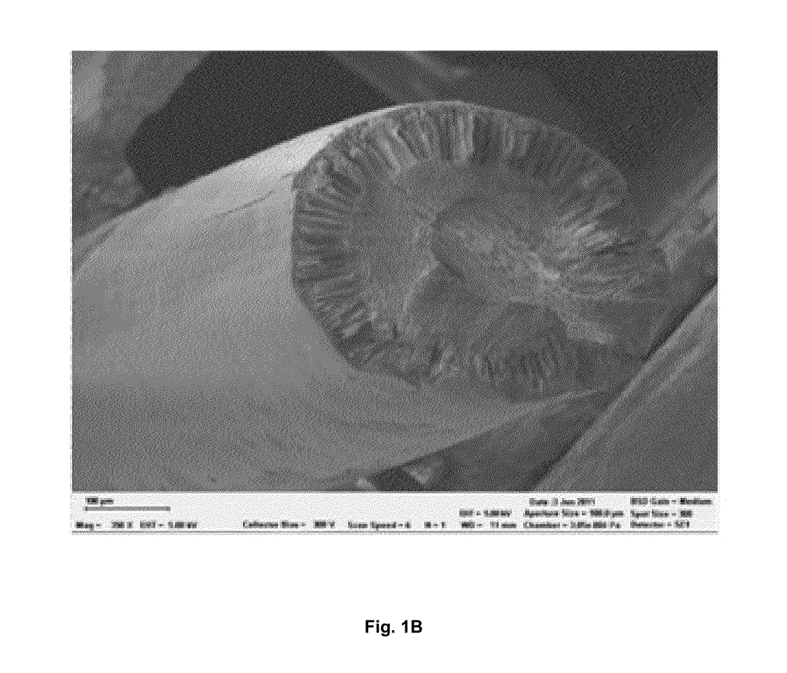

Polyimides can be divided into two main groups—those which can be dissolved into certain organic solvents and those which cannot. The membranes in the latter group are usually prepared from a polyimide precursor such as polyamic acid and/or their salt mixtures which can be dissolved in organic solvents to allow for membrane fabrication. Upon fiber fabrication, the polyamic acid/salt membrane is converted to polyimide membranes by thermal or chemical treatment or a crosslinking mechanism. These polyimide polymers are processed as amic acid precursors because upon conversion to imide form, the polymers don't dissolve in typical organic solvents and hence are not processable. Novel polymeric hollow fiber membranes with asymmetric morphology (FIG. 1) were fabricated by using polyamic acid (diphenyl tetracarboxylic dianhydride (ODPA)/oxy-dianiline (ODA)) formulated into a polyamic acid spinning solution containing a mixture of polyamic acid (ODPA-ODA)/solvent (NMP, THF)/non-solvent (water, ethanol)/additive (polyvinylpyrrolidone).

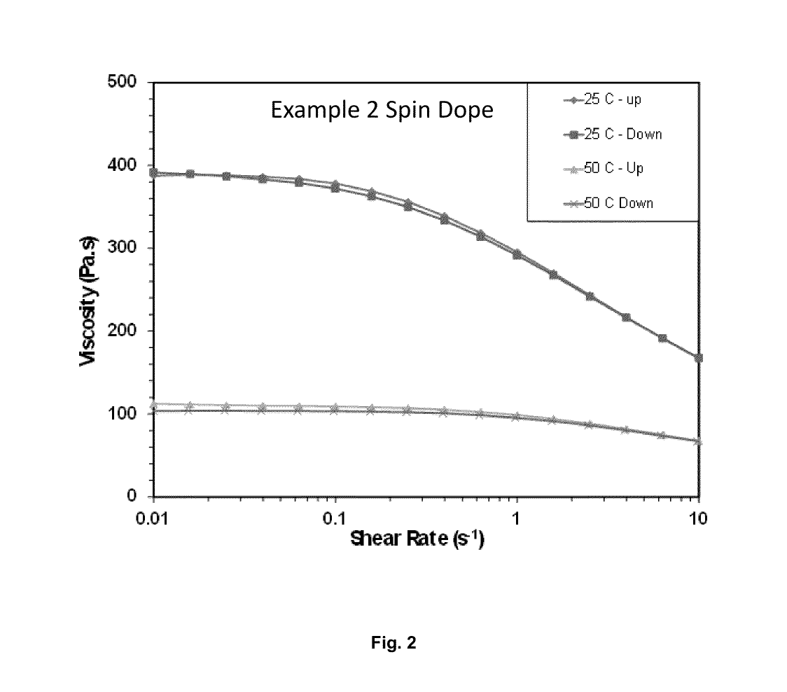

The fibers were extruded, in one example, using a dry jet-wet quench hollow fiber extrusion technique by tuning various parameters (extrusion rate, spinning solution temperature, coagulation bath temperature etc.). The extruded fibers have a thin separation skin layer (<1 μm) formed in the air gap by evaporation of volatile solvents (THF) in the dope mixture and a porous support structure formed due to the immersion of the nascent membrane in a non-solvent coagulation bath (water) as shown in FIG. 2.

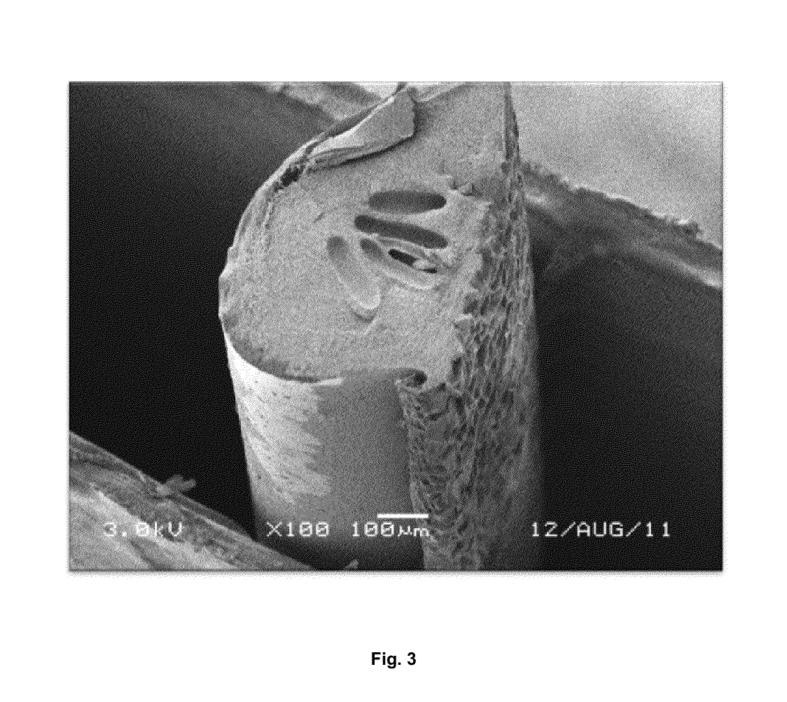

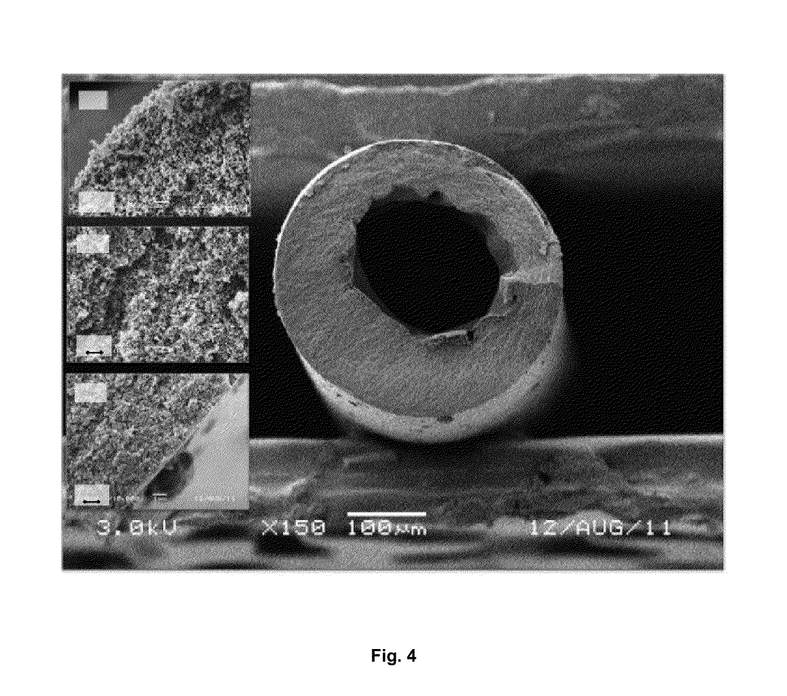

Upon fabrication, the fibers are cross-linked/cured using an optimized thermal protocol into highly robust membranes as shown in FIG. 3. The fibers (5-10) were then potted into a module with a shell-and-tube geometry for gas separation performance testing as shown in FIG. 4. The porous layer provides support to the membrane while the dense, thin layer can, in one example, selectively separate H₂ from other components of the gas stream, such as CO₂, CO and H₂S. While all of the gases in the stream will diffuse through the membrane to some degree, the smaller molecules (such as H₂) diffuse through at a faster rate. This is quantified by the selectivity, or the ratio of the permeances of two gases. N2 or Ar are used, in one example, as a sweep gas to collect the purified H₂ in the permeate stream.

The inventors of the instant application disclose methods for making an asymmetric hollow fiber membrane, which can be used for gas separation. The presently taught membrane has several advantages over existing membranes, including for example, good mechanical strength suitable for practical usage.

In particular, one aspect of the present disclosure is directed to a membrane for gas separation, comprising asymmetric hollow polyimide fibers derived from a precursor composition comprising polyamic acid and an additive, wherein said membrane is a heat resistant membrane and is operable up to about 350° C. In one embodiment, the asymmetric hollow membrane is made from a one step extrusion of a polyamic acid spinning solution comprising polyamic acid, solvent, non-solvent, and an additive.

Another aspect of the present disclosure is directed to a method for the production of an asymmetric hollow fiber membrane comprising: preparing a dope solution comprising a poly(amic acid), a non-solvent, and one or more of solvents selected from the group consisting of NMP, N,N-dimethylacetamide, and N,N-dimethylformamide, and tetra hydro furan; dissolving an additive in said dope solution to form a viscous dope mixture; and spinning said dope mixture to form a polyimide-based asymmetric hollow fiber membrane. In one embodiment, the one or more solvents may be chosen from a larger group of solvents, examples of which are provided herein.

Applications for the presently taught membranes include, for example, high purity H₂ production, carbon capture, and chemical manufacturing (e.g. ammonia and/or methanol production). Hollow fiber membranes were formed with the specific dope formulation, spinning process parameters and thermal curing protocol. Asymmetric hollow fiber membranes were prepared by a hollow fiber spinning process by the formation of the separation skin layer in the air gap by evaporation of volatile solvents in the dope mixture and formation of the porous support structure by immersion of the nascent membrane in a non-solvent bath. Asymmetric hollow membranes are highly advantageous compared to coated composite membranes where a support substrate (hollow fiber or porous metal/ceramic tube) is used. A coating layer increases the cost of the membranes while also adding several complex processing steps, while asymmetric fiber spinning is a one-step process. A coating layer can also delaminate versus in an asymmetric membrane approach described here, where both the support and selective layer are inherently coupled to each other.

The polyamic acid material used in the present disclosure was (diphenyltetracarboxylic dianhydride (ODPA) and oxy-dianiline (ODA)). The membrane is used, for example, for H₂ purifications at high temperatures (for example, 150-350° C.). In one example, other polyamic acids are within the scope of the present disclosure and can be used to make the desired membrane. In one embodiment, the asymmetric hollow fiber membrane comprises a polymer selected from a group consisting of aromatic polyamides, aliphatic polyamides, polyetherimides, polyethersulfones, polyetheresters, polysulfones, polyvinylidene fluoride, polybenzimidazoles, polybenzoxazoles, polyacrylonitrile, polyazoaroaromatics, polyamide imides, polyamide esters, polyimides, polyesters, and blends thereof, copolymers thereof, and substituted polymers thereof.

In one example, an additive is used in conjunction with the polyamic acid. The additive is a material capable of increasing the hydrophilic character of the polyimide fibers. The additive can be selected from a group consisting of polyvinylpyrrolidone, polyetheretherketones, lithium nitrate, poly(ethylene glycol) (PEG), lithium chloride (LiCl), acetic acid, phosphoric acid, and propionic acid. The membrane of the presently taught disclosure may further comprise one or more solvents, or a mixture thereof, selected from the group consisting of phenol, cresol, xylenol, catechol, 3-chlorophenol, 4-chlorophenol, 4-bromophenol, 2-chloro5-hydroxytoluene, N-methyl2-pyrrolidone, N,N-dimethylformamide, N,N-diethylformamide, N,N-dimethylacetamide or N,N-diethylacetamide, tetrahydro furan, dimethylsulfoxide, C1-C6 alcohols, toluene, methylene chloride, and acetone.

Non-solvents used in the teachings of the present disclosure, include water, methanol, ethanol, n-propanol, isopropanol, acetone, ethylene glycol, glycerol, priopionic acid, methyl ethyl ketone, diethyl ketone, ethyl propyl ketone, or mixtures thereof. In a particular example, the additive is polyvinylpyrrolidone and the non-solvent is water or ethanol. The solvent, on the other hand, for the preparation of the dope solution comprises one or more solvents, or a mixture thereof, selected from the group consisting of phenol, cresol, xylenol, catechol, 3-chlorophenol, 4-chlorophenol, 4-bromophenol, 2-chloro5-hydroxytoluene, N-methyl2-pyrrolidone, N,N-dimethylformamide, N,N-diethylformamide, N,N-dimethylacetamide or N,N-diethylacetamide, tetrahydro furan, dimethylsulfoxide, C1-C6 alcohols, toluene, methylene chloride, and acetone.

A polymide precursor is used in one example and said precursor composition comprises about 5 to 50 weight percent solution of poly(amic acid) in a solvent. The polyamic acid may be obtained by reacting a dianhydride monomer with a diamine monomer. In one example, the composition further comprises n-methyl-2-pyrrolidone (NMP). The dianhydride monomer can be (diphenyltetracarboxylic dianhydride (ODPA) and the diamine monomer can be oxy-dianiline (ODA)). The polyimide may be obtained by curing a polyamic acid, and the polyamic acid can be obtained by reacting a dianhydride monomer with a diamine monomer.

For the purification of H₂ from coal/Natural Gas (NG) based syn-gas streams membranes with high thermal (200-400° C.), chemical (prolonged stability under H₂S, Steam, CO) and stability are desired. Various membrane materials and processes have been proposed for the application. Ceramic, zeolite, metallic and polymeric membranes are proposed. Ceramic, zeolite and metallic membranes provide better H₂ separation performance compared to polymeric membranes, however, are often brittle, expensive and difficult to process. The disadvantages of the other membranes are advantages of polymeric membranes but for H₂ separations and generally for high temperature separation processes, polymeric membranes (1) cannot withstand high temperatures, and (2) selectivity or separation performance goes down at higher temperature and polymeric membranes are not chemically robust under such conditions. The inventors of the instant application have discovered that the instantly taught polymers provide advantages which conventional polymers do not.

The inventors' asymmetric hollow membranes have a lower cost of production, are highly processable and easy to scale-up. For effective gas separations, the membrane selective layer is defect-free while still being thin (<1 μm in one example) to enable high permeances or flux. Polymeric membranes can be made by making a composite membrane with the selective polymer layer coated on to a support substrate (hollow fiber or porous metal/ceramic tube) or by making asymmetric membranes where both the support and selective layer are of the same material and are formed by a fiber extrusion process.

Moreover, the presently taught asymmetric hollow membranes have high separation properties at high temperature, and the membrane is chemical robust. For example, in one embodiment, the membrane is operable from about 20 to about 350° C. The membrane can operate at up to about 400° C. In a particular embodiment, the membrane is capable of separating hot gases or vapors, where the temperature is about 30, about 60, about 100, about 150, about 200, about 250, about 300, about 350, or about 400° C. In one example, the temperature is at about 350° C. In one example, the membrane is capable of separating hot gases or vapors, where the temperature is from about 150 degrees to 350° C. In addition to being heat resistant, the membrane is also resistant to chemical degradation, such that the membrane is resistant, for example, to changes in its structure and membrane function as a result of treatment with mercury, steam, hydrogen sulfide, carbon monoxide, fly-ash, SOx, NOx, acid gases.

One aspect of the present disclosure is directed to a method of selectively separating and recovering at least one kind of gas from a mixed gas or vapor, comprising feeding the mixed gas or vapor to a feed side of a gas separation membrane comprising an asymmetric hollow fiber made as according to the presently disclosed method, and selectively passing the at least one kind of gas or vapor of the mixed gas or vapor through the gas separation membrane to a permeate side of the gas separation membrane. Another aspect of the present disclosure is directed to a method for selectively separating and recovering a particular gas from a mixed gas containing two or more gases or vapors, where the method comprises passing said gas or vapor through a membrane made by the process as described above.

Yet another aspect of the present disclosure is a method of selectively separating and recovering at least one kind of gas from a mixed gas or vapor, comprising feeding the mixed gas or vapor to a feed side of a gas separation membrane comprising the asymmetric hollow membrane made as outlined in claim 1, and selectively passing the at least one kind of gas or vapor of the mixed gas or vapor through the gas separation membrane to a permeate side of the gas separation membrane.

The presently disclosed method can further comprise an extrusion step wherein a coagulation liquid into which the dope solution is extruded during membrane formation is selected from the group consisting of water, and an aqueous solution of ethanol, methanol, hexane, C1-C6 hydrocarbons, glycol, glycerol, acetic acid, propionic acid and mixture thereof. After the spin dope is mixed with the additive, the spin dope is heated, in one example, to no more than about 80° C. to achieve the desired dope uniformity and additive dissolution.

The asymmetric hollow-fiber gas separation membrane has sufficient mechanical strength even after the heat-treatment at a maximum temperature of up to 350° C. Moreover, since the presently taught membrane is made into an asymmetric hollow fiber, it has a high surface area per unit volume, as well as being easy to manufacture and at low cost. In the present disclosure, highly robust, thermally stable, asymmetric hollow fiber membranes forms were successfully fabricated, a cross-linking protocol was developed and the fibers were tested for hydrogen separation performance from a syn-gas mixture (H₂/CO₂).

The membrane is used, for example, in high purity hydrogen production, carbon capture, chemical manufacturing, power generation, refinery application, Fischer Tropsch liquids, fuel cell applications, water/organic separations, and the like. As such, the asymmetric hollow fiber membrane according to the present invention has a great application value in industry. The hollow fiber asymmetric membrane obtained by the method according to the present invention can be used to separate a variety of gases, including steam, hydrogen gas, carbon dioxide, oxygen gas, nitrogen gas, methane, C1-C4 hydrocarbons, heavier hydrocarbons, carbon monoxide, hydrogen sulfide and hot mixed gases or vapors that contain organic compound. In a particular example, the asymmetric hollow-fiber gas separation membrane as presently taught herein is used to separate hot mixed gases or vapors that contain organic compound.

The asymmetric hollow fiber membrane of the present disclosure is suitable as a practical high-performance gas separation membrane. In one example, separation between hydrogen gas and a hydrocarbon gas, e.g., methane gas, separation between hydrogen gas and nitrogen gas, separation between helium gas and nitrogen gas, separation between carbonic acid gas and methane gas, separation between oxygen gas and nitrogen gas, and the like can be accomplished advantageously. In a particular example, the asymmetric hollow fiber membrane of the present disclosure is used to separate components in syn-gas, natural gas, coal gas, petrochemical stream, city gas, diesel fuel, gasoline, LPG, jet fuel, refortmate gas, naptha and mixtures thereof.

For example, the membrane of the presently taught disclosure exhibits gas separation performance in which the permselectivity for hydrogen/carbon dioxide is from about 5 to 10, the hydrogen/carbon monoxide permselectivity is from about 30 to 60, the permselectivity for water/hydrogen is from about 5 to 10, and a carbon dioxide/methane permselectivity is from about 5 to 20. The membrane is used, for example, for hydrogen purifications at high temperatures of from about room temperature to about 350° C.

In one example, the aforementioned “polyimide” is composed of source materials of a polyimide and/or a polymerized and imidized product of the source materials. The polymerized and imidized product includes a polymer having a high polymerization degree, and monomers and oligomers having a low polymerization degree, which are present in the initial stage of polymerizing and imidizing the source materials of a polyimide. For example, the polymerized and imidized product is composed of monomers (formed through imidization between two molecules) and/or polymers (formed through imidization among three or more molecules). In one example, in the polymerization and imidization, the percent of imidization is about 50% or more; in another example, the imidization is substantially completed.

The method of the present disclosure can further comprise subjecting the dope mixture to a solvent exchange step, followed by imidizing or curing. In one example, the curing environment comprises nitrogen, air, oxygen, vacuum, and/or enriched nitrogen, vacuum, or inert environment (Argon, Helium etc.). In a particular example, the curing is performed in the presence of nitrogen. The thermal treatment protocol can include room temperature to about 25° C. The thermal hold time is from 1 second to 100 hours, in one example, and the heating rate can be between 0.1 C./min to 10 C./min. The flow rate of nitrogen or exchange rate in the oven is, in one example, from about 1 to about 1000 mL/min. The exchange rate may be, in another example, from about 1 to about 100 per minute. The degree of imidization can be between 10-100%.

There are a variety of applications that depend on the ability to separate one gas from another, for example, chemical manufacturing, H₂ purification for fuel, and carbon dioxide capture and sequestration. Membrane technologies have the potential to improve process efficiency and reduce the cost when compared to conventional technologies, such as pressure swing absorption or cryogenic distillation systems. While membrane systems have been commercially available for decades, further development is needed to increase separation performance, reduce costs, tackle scalability issues and adapt performance to process conditions. The polyimide hollow fiber membrane developed here utilizes chemically, thermal robust polymeric material and have superior gas separation performance compared to other polymeric membranes.

Moreover, the presently taught membranes are easier to fabricate and have lower cost compared to other membranes based platforms. The present disclosure teaches new asymmetric hollow fiber membranes using the specialty polyamic acid/polyimide. This has several advantages, including the fact that the fibers are fabricated by a one-step extrusion technique and do not require multiple processing steps for example in composite coated membranes. The fibers are easily scalable and the inventors were able to achieve >60 m/min production rates (typical industrial production rate). Hollow fibers provide a high surface area to unit volume compared to other membrane platforms such as plate in frame or spiral wound membranes. The polyimide material that was chosen and studied in detail is (ODPA-ODA); this is stable at high temperatures (200 to 400° C.) and under stringent syn-gas conditions (H₂S, CO, Steam), provides and unlike various other polyamic based solutions is stable when exposed to water, which acts as a coagulation bath during the fiber extrusion process.

One aspect of the present disclosure is directed to a method for selectively separating and recovering a particular gas from a mixed gas containing two or more gases or vapors, said where the method comprises passing said gas through a membrane comprising asymmetric hollow polyimide fibers derived from a precursor composition comprising polyamic acid and an additive. In one embodiment, the method is carried out at a temperature in the range of about 150° C. to about 350° C. In one example, the present disclosure is directed to an asymmetric hollow fiber membrane, a dope solution composition for forming an asymmetric hollow fiber membrane, and a method of preparing an asymmetric hollow fiber membrane using the same.

### EXAMPLES

The disclosure, having been generally described, may be more readily understood by reference to the following examples, which are included merely for purposes of illustration of certain aspects and embodiments of the present disclosure, and are not intended to limit the disclosure in any way.

The polyimide hollow fiber membrane developed here utilizes chemically, thermal robust polymeric material, is easy to fabricate and have lower cost compared to other membranes based platforms.

Polyamic Acid Hollow Fiber Fabrication

The polyimide precursor (VTEC PI-080-051, R. Blaine Industries) produced as an 18 weight percent solution of poly(amic acid) in n-methyl-2-pyrrolidone (NMP) solvent with a viscosity of 30 Pa·s was selected as the polymer solution to create the polymer spin dope mixture.

Tetrahydrofuran (THF) (Anhydrous 99.9%, Sigma-Aldrich, Milwaukee, Wis.) was used as a high volatility solvent to promote skin layer formation of the hollow fiber. Ethanol (Anhydrous 99.9%, Sigma-Aldrich) was used as a non-solvent in the dope formulation. Typically, pure polymer hollow fiber membrane spin dopes have a viscosity of ≈100-500 Pa·s and hence polyvinyl pyrrolidone (PVP) (Mₙ≈360,000, Sigma-Aldrich) was added as an additive to the dope mixture due to its ability to act as a pore former and also increase the dope viscosity making the dopes spinnable. All chemicals and polymers were used as received without any further purification. PVP was dried at 80° C. for 12-24 h under vacuum to remove sorbed water vapor.

A one-phase dope composition in close proximity to the cloud point having appropriate viscosity (determined by viscosity measurements) was selected for scale-up (500 mL dope mixtures). From the cloud point experiments and observations during the fiber spinning process, two sets of dope compositions were developed as described in Table 1.

TABLE 1
Spin dope compositions identified for hollow
fiber membrane creation (units in wt. %)

| | Polyamic_acid | | | |
|---|---|---|---|---|
| ID | solution | THF | PVP | Ethanol |
| Example 1 | 80.1 | 10.9 | 6 | 3 |
| Example 2 | 89 | 0 | 8 | 3 |

A mixture of solvent and non-solvent, referred to as the bore fluid (or internal coagulant), was also prepared by adding measured quantities of solvent and non-solvent. The bore fluid composition was tuned as per spin dope formulation. Example 1 and Example 2 bore fluid compositions used in this work are summarized in Table 2. Bore fluid compositions of 95/5 wt. % (Example 1) and 70/30 wt. % (Example 2) NMP/Water mixture were used. In one example, during the hollow fiber spinning process, there is a spin dope which is the polymer solution, mentioned in table 1. Simultaneously, a bore fluid solution is passed on the inside of the nozzle annulus which gives the fiber its hollow structure. In one example, the polymer solution is mentioned in Table 1 and the bore fluid composition is mentioned in Table 2.

TABLE 2
Summary of bore fluid compositions (units in wt. %)

| Bore Fluid | NMP | Water |
|---|---|---|
| Example 1 | 75 | 25 |
| Example 2 | 70 | 30 |

Method for Fabricating Hollow Fiber Membrane

For spin dope preparation, a measured amount of polyamic acid solution was added to the 1000 mL glass jar (Quorpak, Bridgeville, Pa.), followed by the addition of desired quantities of solvents (THF), non-solvents (ethanol) and additive (PVP) to get the desired composition. The dope was sealed and put on a roller at room temperature (Example 1 dopes) or heated to 40-50° C. (Example 2 dopes) with the help of an IR lamp, until complete additive dissolution and dope uniformity was observed. The spin dope and bore fluid were then poured into syringe pumps (Model: 500 DM, Teledyne Isco, Lincoln, Nebr.) for spinning and kept undisturbed for about 12 h to ensure complete degassing of the dope solution.

Hollow fiber membranes were made by the dry jet-wet quench solution spinning technique. Table 3 summarizes the various spinning parameters used in the project with their typical range. The dope/polymer solution has a flow rate of about 180 to about 1000 mL/hr. This dope solution was fed to the outer compartment, and simultaneously, the bore fluid (or internal coagulant) with a flow rate of about 60 to about 180 ml/hr was fed into the inner compartment. In one example, the core dope flow rate was varied between 180-1000 mL/hr, while, the bore layer flow rate was varied between 0.3-0.5 times the core flow rate. The bore fluid and the core dope were filtered through 15 μm and 40 μm mesh size in-line filters to remove any impurities or insoluble particles before entering the nozzle channels. Spinning temperatures (spinneret, pumps and transfer lines temperature) of 25° C. and 40° C. were used.

The extruded nascent fiber was then passed through an adjustable air gap (dry jet) varied between 0-15 cm before entering the external coagulant or quench bath (wet quench) where it phase separates and vitrifies. In the air gap, volatile solvents (THF) and non-solvents (ethanol) leave the dope, thereby driving the outer surface composition close to the vitrified region and forming the skin layer. Tap water was used as an environmentally friendly and easily available quench bath (1 m deep) medium. A rotating water wheel located in the coagulation bath was used to maintain uniform mixing and bath temperature. Quench bath temperatures of 30° C. and 50° C. were performed. In the quench bath, ingress of the non-solvent (water) and outflow of the solvents drive the composition of the region below the skin layer into the two-phase region, thereby forming the substructure. In this way, spinning through both the air gap and entering the quench bath results in the desirable asymmetric morphology.

The fiber passes under two Teflon guides located in the quench bath and is either collected by a free-fall mechanism into a collection bath filled with DI water or onto a 25 cm (Example 1 fibers) or a 75 cm (Example 2 fibers) circumference rotating take-up drum continuously replenished with fresh DI water. The take-up rate was also a variable factor with typical speeds up to 30 m/min used in the study with a maximum take-up speed of 70 m/min achieved in the runs. Once collected, each state was allowed to rotate on the drum at speed of around (<10 m/min) for about 15 min to allow complete phase separation and vitrification.

Fibers were spun under identical conditions (called a ‘spin state’) comprising 10-20 fibers, 75 cm in length, and were removed from the take-up drum and tied together. By manipulating various spinning parameters, several spin states were collected and analyzed. Each spin state was individually soaked in 1 m long, 2.5 cm diameter solvent exchange tubes to prevent curling and entanglement of the fibers. The fibers were soaked in de-ionized (DI) water for up to 3-5 days changing with fresh DI water daily. The exchange with fresh DI water helped in leaching out residual solvents and non-solvents from the fiber substructure. The PVP additive was also leached out owing to its solubility in water. Removal of PVP helps in formation of a more open and porous fiber substructure. The water present in the fiber sub-structure was then solvent exchanged by immersion of spin states for 30 minutes each in three batches of fresh methanol followed by three batches of fresh hexane. To remove the residual hexane, fibers were hung in a fume hood at room temperature for 1 hour and stored for further characterization.

TABLE 3
Spinning conditions for dual layer fiber sorbents.

| | |
|---|---|
| Dope (Core) | |
| Pump temperature | 40° C. (Example 1, Example 2), 25° C. (Example |
| | 2) |
| In-line temperature | 40° C. (Example 1, Example 2), 25° C. (Example |
| | 2) |
| Flow rate | 180 to 1000 mL/h (typically 180 to 300 mL/hr) |
| Bore fluid | |
| Composition | NMP:Water = 95:5 wt. % (Example 1), 70:30 |
| | (Example 2) |
| Temperature | Room temperature |
| Flow rate | 60-500 mL/h (0.3-0.5 of core flow rate) |
| Spinneret | 40° C. (Example 1, Example 2) and 25° C. |
| temperature | (Example 2) |
| Air temperature | Room temperature (≈25° C.) |
| Air-gap | 0-15 cm (typically 10 cm) |
| Quench bath | |
| Media | Tap water |
| Depth | 1 m |
| Temperature, T_{quench} | 30° C. and 50° C. (typically 30° C.) |
| Take-up rate | 15-70 m/min (typically 30 m/min) |

### Example 1

### Polyamic Acid Hollow Fiber Fabrication

Cloud point technique was utilized to formulate the Example 1 spin dope and bore fluid compositions as described in Table 1 and Table 2 respectively. A dope temperature of 40° C. and a quench bath at temperature≈30° C. were used. Example 1/Example 2 fibers were made with the representative dope and bore fluid compositions mentioned in Tables 1 and 2. You elaborate the differences below itself. The problems with Example 1 fibers as described below led to the creation of Example 2 fibers.

The dope was found to have a low viscosity and slow phase separation rate, possibly due to high dope temperature (40° C.). The slow phase separation could be attributed to the experimental binodal curve determined at room temperature shifting at higher process temperatures. This could have led to a slower phase separation of the nascent fiber in the non-solvent water coagulation bath. Take up rates of 15 m/min were feasible, with higher take-up rates leading to fiber strand breakage. THF was found to be a swelling agent for the dope and caused the nascent fiber to stick to the guide roles causing inability to be drawn onto the take-up drum. The fibers were solvent-exchanged using the protocol described earlier. The polyamic acid fibers were found to be stable even upon prolonged exposures of soaking (3-5 days) in the solvent exchange bath.

FIG. 1 shows the SEM images of the as-spun Example 1 hollow fibers. Finger-shaped macrovoids were observed in the outer part of the hollow fiber. Macrovoids can be attributed to the low viscosity of the spin dope and can be reduced or eliminated by increasing the dope viscosity which delays the diffusion of solvent into the polymer-lean phase that causes the growth of macrovoids.

Typical water-gas shift operations involving H₂/CO₂ separations are conducted at gas pressures of up to a maximum of 30 bar (450 psi). Macrovoids can reduce the mechanical strength of the fiber causing it to burst or collapse at high trans-membrane pressures. Macrovoids can also cause non-selective pathways for gas/water vapor flow rendering the thin-selective layer ineffective.

The hollow fiber membranes were observed to have a tear drop-shaped bore structure, possibly due to slow phase separation rate in the air-gap and the water coagulation bath before it hit the first guide role. The slow phase separation rate could be attributed to the high NMP (solvent) content in the bore fluid. A reduction in the solvent content of the bore fluid can lead to a faster phase separation of the bore giving it the circular, uniform structure. One spin run was completed using Example 1 spin dope and bore fluids compositions. To reduce or eliminate the formation of macrovoids in the fiber wall and formation of uniform circular bore layer, Example 2 spin dopes and bore fluid compositions were developed.

### Example 2

### Polyamic Acid Hollow Fiber Fabrication

Cloud point technique was used to modify the dope composition based on what was learned from Example 1 hollow fiber fabrication. The modified dope composition is summarized in Table 1. The PVP additive content was increased from 6 to 8 wt. % to increase the dope viscosity and THF (high volatility solvent) was removed. The ethanol (high volatility non-solvent) content was kept the same. The bore fluid composition was modified to a 70:30 wt. % NMP:Water to give a neutral bore fluid. Spinning temperatures (spinneret, pumps and transfer lines temperature) of 25° C., 40° C. were studied.

The dope viscosity was found to be appropriate for fiber spinning as shown by viscosity measurements. The spin dope indicated a viscoelastic behavior with shear thinning behavior observed at higher shear rates. The dope viscosity was found to reduce at higher temperature. In the first run with Example 2 spin dope, a dope temperature of 25° C. was used. The viscosity of the spin dope led to a high pressure build-up in the nozzle dope compartment, leading to possible misalignment of the nozzle. The high viscosity led to a large die swell at the nozzle annulus and the bore needle misalignment led to the bore fluid flowing through the side of the nascent fiber. This undesired phenomenon led to formation of a solid fiber with a semi-circular structure, with a porous flat-region possibly caused by the bore fluid flow as shown in Figure.

In the following runs, the spinning temperatures (spinneret, pumps and transfer lines temperature) was adjusted to 40° C. and this was found to give appropriate viscosity to spin hollow fibers. The adjusted viscosity led to elimination of the macro voids from the fiber morphology as shown in FIG. 4. The polyamic acid hollow fibers have a desired porous uniform sub-structure with a thin outer skin layer. Fibers were found to be strong and could be easily collected on to the take-up drum with collection rates up to 70 m/min possible, with typically collection rates of 30 m/min. Typically, take-up rates of 60 m/min were desired for industrial scale operations. Fibers spun at a low dope flow rate (180 to 300 mL/hr) and correspondingly low bore fluid flow rate (60 to 100 mL/hr) were found to be more concentric, possibly due to a lower die swell at the nozzle annulus. In one example, an air-gap of 10 cm was found to work well.

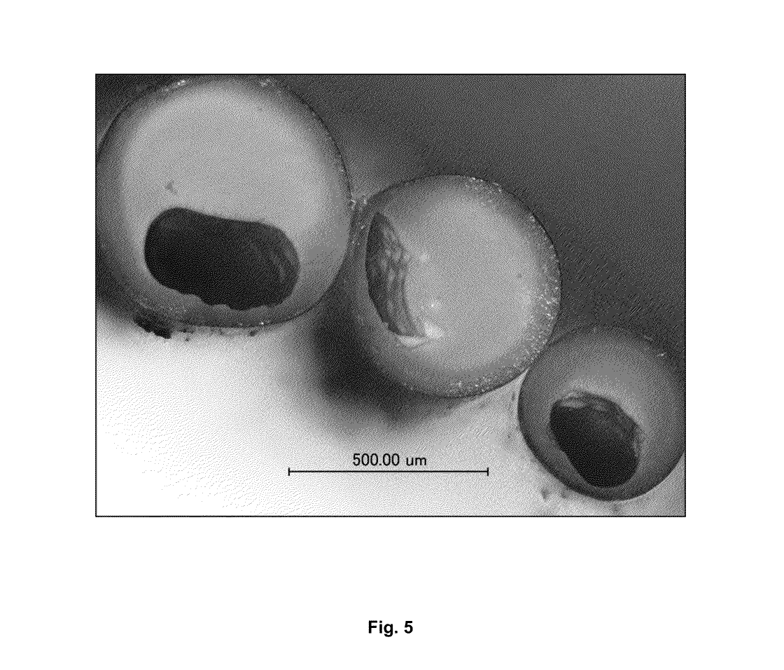

Even though the dope composition and spinning conditions were optimized, the nozzle alignment could get disturbed due to the high viscosity dope fluid. Once misaligned, it was found to be difficult to align the nozzle once the spinning run was underway. Fibers with a misaligned bore structure are shown in FIG. 5. The nozzle misalignment primarily affected the concentricity of the fiber, leading to variations in the fiber wall thickness as shown in FIG. 5. The solvent exchanged polyamic acid hollow fibers were then forwarded to imidization or curing. Three spin runs were completed using Example 2 spin dope and bore fluids compositions. In one spin run, hollow fibers were found to be circular in shape, concentric with the desired porous substructure and thin skin layer. In another spin run, hollow fibers were found to be slightly non-concentric due to misalignment of the nozzle bore needle.

Curing Process Development

The solvent exchanged polyamic acid hollow fibers were imidized to form a thermally and chemically robust polyimide hollow fiber membrane. Thermal imidization method was chosen due to simplicity of use and scale-up compared to the chemical imidization method.

The imidization of the fibers could be affected by a number of factors including, for example, the type of atmosphere, amount of water present, solvents/byproducts removal rate, heating rates, and temperatures and soak times. Some optimization of the curing process was made possible by thermogravimetric (TGA) analysis, nuclear magnetic resonance (NMR) spectroscopy, infrared (IR) spectroscopy, and scanning electron microscopy (SEM) studies. A bench-scale fiber curing oven was designed and fabricated to scale-up the curing protocol allowing imidization of multiple polyamic acid hollow fiber strands of up to 1 m length.

TGA Study

Fibers were analyzed in platinum sample pans with Inconel capped bale wires using a TA Instruments Q5000 TGA (Serial #: 5000-0108) under nitrogen flow, with a purge rate of 10 mL/min in the balance chamber. Calibration verification was performed using alumel and nickel with expected Curie point transitions of 154° C. and 358° C. The experimental values were found to be within 5° C. of the expected values when analyzed at a ramp rate of 2° C./min under a nitrogen purge of 50 mL/min. The 30 minute hold at the beginning of the run allowed time for room air to exchange with nitrogen purge before the start of the heating run.

Three TGA runs were performed using the conditions specified in Table 4 through

Table 6 while the other two protocols explored the effect of reducing the time taken and the gas flow rate for the imidization process.

TABLE 4
Conditions for TGA run ‘Baseline’

| Hold Temperature | Hold Time |
|---|---|
| (° C.) | (hrs) |
| RT | 0.5 |
| 100 | 1 |
| 150 | 24 |
| 250 | 24 |

| | |
|---|---|
| Temp Ramp Rate (° C./min) | 2 |
| N₂ Flow Rate (mL/min) | 50 |
| N₂ Exchange Rate (per min.) | 10 est. |

TABLE 5
Conditions for TGA run “short run”

| Hold Temperature | Hold Time |
|---|---|
| (° C.) | (hrs) |
| RT | 0.5 |
| 100 | 0 |
| 150 | 6 |
| 250 | 6 |

| | |
|---|---|
| Temp Ramp Rate (° C./min) | 2 |
| N₂ Flow Rate (mL/min) | 50 |
| N₂ Exchange Rate (per min.) | 1 est. |

TABLE 6
Conditions for TGA run “low flow”

| Hold Temperature | Hold Time |
|---|---|
| (° C.) | (hrs) |
| RT | 0.5 |
| 100 | 0 |
| 150 | 6 |
| 250 | 6 |

| | |
|---|---|
| Temp Ramp Rate (° C./min) | 2 |
| N₂ Flow Rate (mL/min) | 5 |
| N₂ Exchange Rate (per min.) | 1 est. |

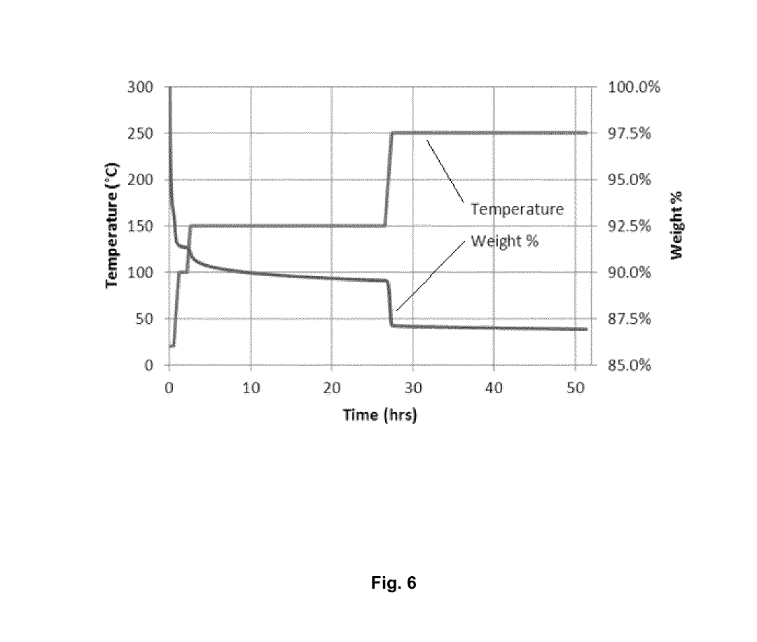

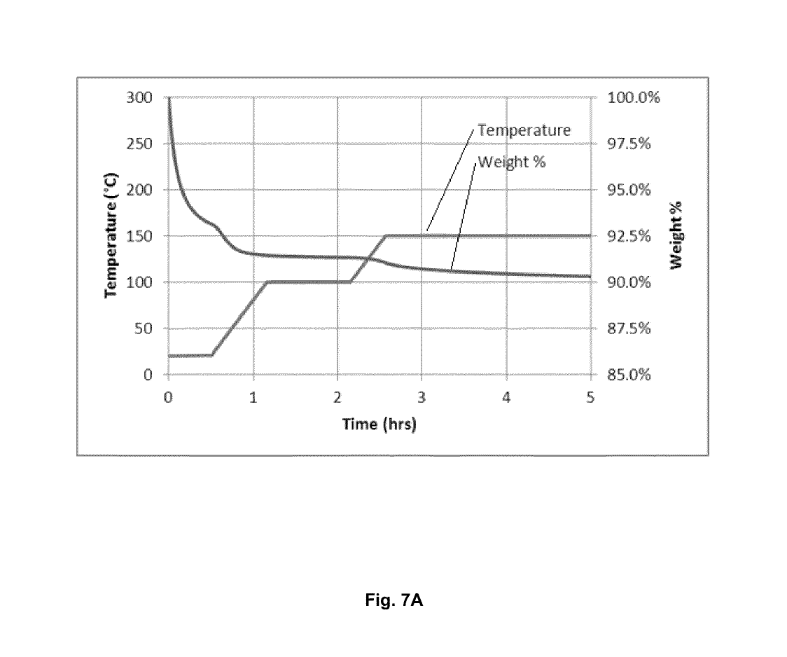

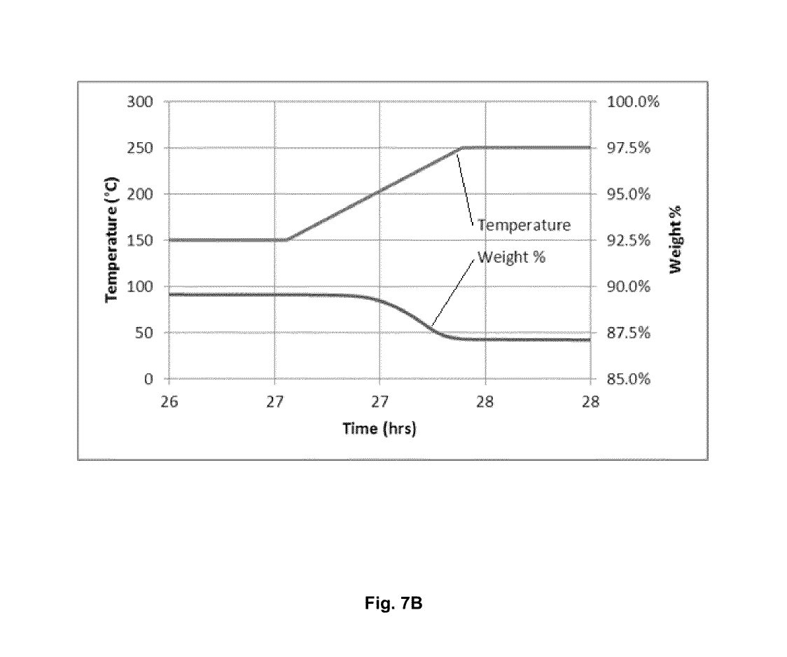

The profile for the “Baseline” TGA run is shown in FIG. 6 with select sections shown in more detail in FIG. 7.

The fibers lost approximately 6.7% of their weight during the 30 minute hold at room temperature. This accounts for more than half of the total weight loss during the TGA run. The fibers were stored in a plastic bag (stagnant air) prior to the TGA run. Therefore, this large weight loss could be physisorbed water or excess hexane which came off in the dry nitrogen stream. The desorption of these components was mostly completed by 80° C., with an additional 1.8% weight loss.

The one hour hold at 100° C. proved to be unnecessary, as no significant weight loss occurred. The sample lost an additional 2 wt % by the end of the 150° C. hold, with the majority (75%) of this weight loss occurring in the first six hours of the hold. This is expected to be from trace NMP and PVP removal.

The next significant weight loss was during the ramp from 150° C. to 250° C., with the highest rate of weight loss occurring at 227° C. The sample lost 2.4 wt % during this ramp. This weight loss could be associated with imidization of the poly(amic acid) to form the polyimide structure with water as a byproduct. The imidization process appears to be completed by the time the sample reached 250° C. The hold at 250° C. was largely unnecessary given that it only resulted in a 0.2% weight loss. These weight losses are summarized in Table 7, along with possible sources for each weight loss.

TABLE 7
Summary of TGA Weight Losses in “Baseline” Run

| Step | Weight Loss (%) | Potential Source |
|---|---|---|
| RT Hold | 6.7% | Physisorbed H₂O, |
| | | Hexane |
| RT to 100° C. | 1.8% | Physisorbed H₂O, |
| | | Hexane |
| 150° C. Hold | 2.0% | Trace NMP/PVP |
| 150° C.-250° C. | 2.4% | Imidization (H₂O) |
| 250° C. Hold | 0.2% | Imidization (H₂O) |

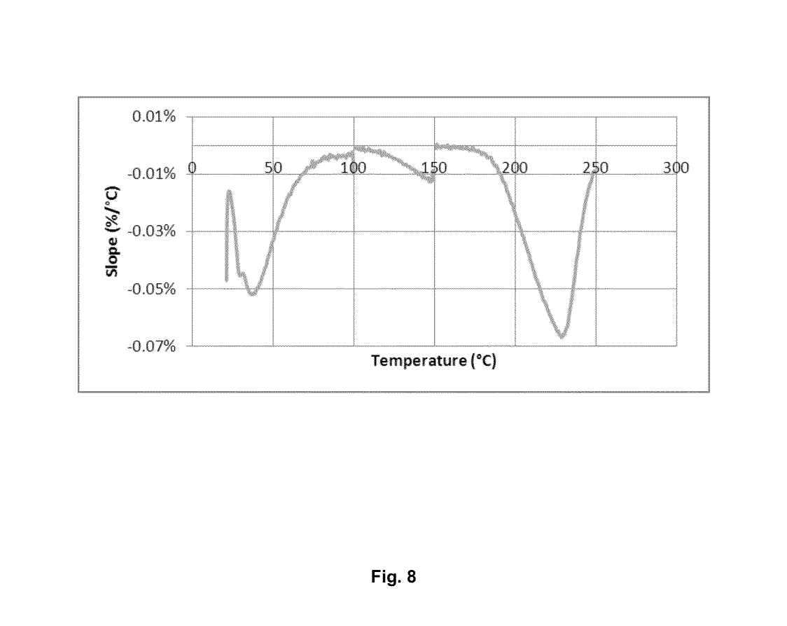

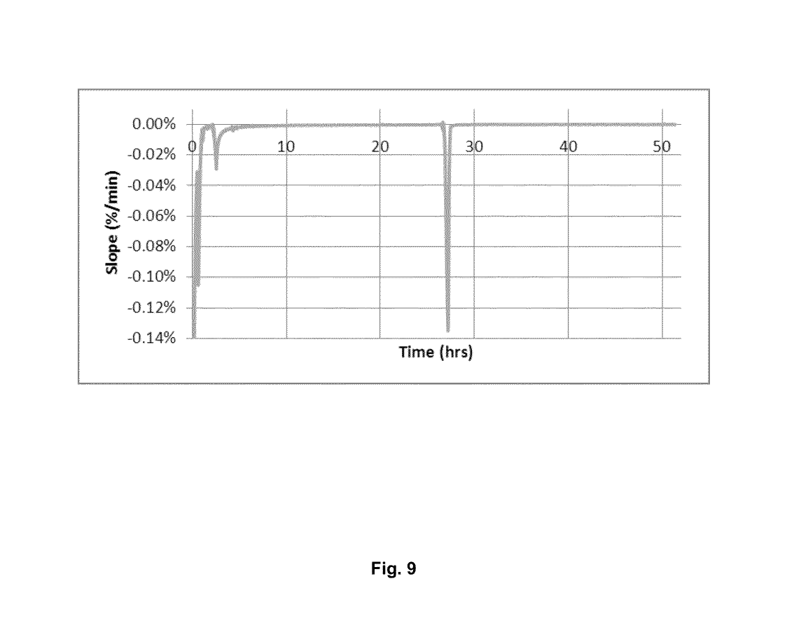

The rates of weight loss during the TGA run were analyzed by plotting the first derivatives of the TGA data. The first derivative of the weight loss with respect to temperature is shown in FIG. 8. The isothermal holds were removed from this data and all temperature ramp rates were 2° C./min during the run. The first derivative of the weight loss with respect to time is shown in FIG. 9. This graph includes all of the run data after the 30 minute hold at room temperature.

The fastest rate of weight loss in the hollow fibers occurred in the beginning of the 30 minute nitrogen sweep at room temperature. The rate of weight loss in the first 2 minutes was around 1.0 wt %/min, but quickly dropped off to less than 0.1 wt %/min after 16 minutes under nitrogen purge. There were three peaks in the rate of weight loss: 1) 37° C., 2) 147° C., and 3) 226° C. Since the second peak was very close to an isothermal hold, it is difficult to determine whether this weight loss rate would have kept increasing without the hold, to peak at a higher temperature. Regardless, the two 24 hour holds at 150° C. and 250° C. were significantly longer than necessary, as evident by the negligible rates of weight loss between 8 and 26 hours and 28 and 51 hours in FIG. 9. Hence, a modified “Short Run” protocol was developed and TGA studies were conducted to verify if results similar to “Baseline” TGA studies were obtained.

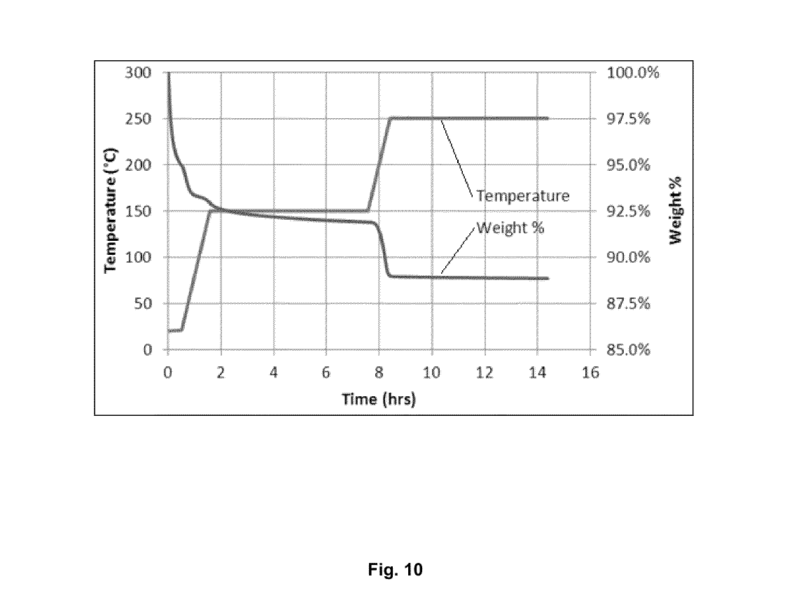

The TGA results from the “Short Run” were similar to the “Baseline” TGA data. The difference was to eliminate the isothermal sections with minimal weight loss (i.e. eliminate the 100° C. hold and significantly reduce the 150° C. and 250° C. holds). The summary of weight losses during the “Short Run” is shown in Table 8, with the profile for the run shown in FIG. 10.

TABLE 8
Summary of TGA Weight Losses in the “Short Run”.

| Step | Weight Loss (%) | Potential Source |
|---|---|---|
| RT Hold | 5.0% | Physisorbed H₂O, |
| | | Hexane |
| RT to 150° C. | 2.0% | Physisorbed H₂O, |
| | | Hexane |
| 150° C. Hold | 1.9% | Trace NMP/PVP |
| 150° C.-250° C. | 2.0% | Imidization (H₂O) |
| 250° C. Hold | 0.3% | Imidization (H₂O) |

The data showed that by appropriate optimization, the length of the different hold times can be shortened. In one example, treatment environment, for example vacuum or air or inert gas such as nitrogen, could be used.

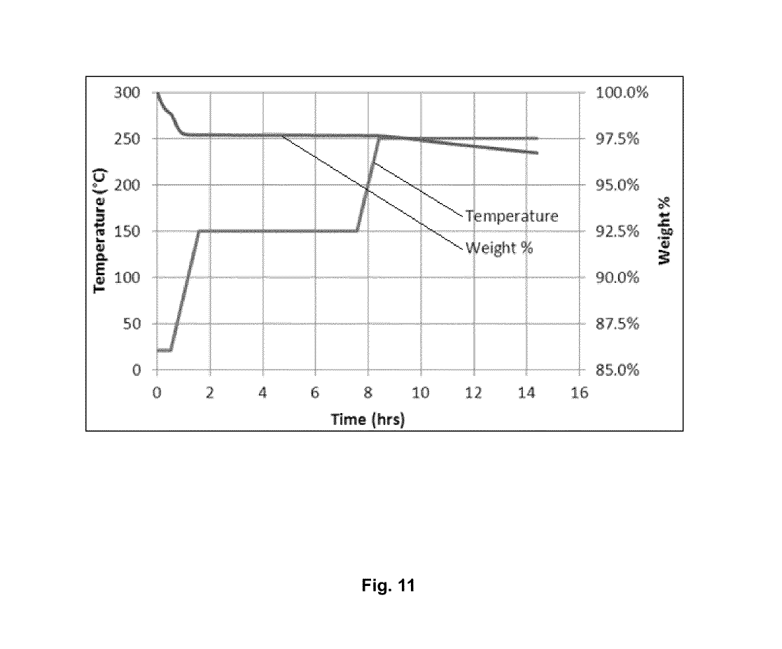

In order to study the effect of the purge gas environment, TGA studies were conducted with lower flow rate of purge gas. The results from the “Low Flow” run were found to be significantly different from the previous two runs. The fibers did not fully imidize during this run and remained whitish is color, compared to the orange color that imidized fibers take on. The profile for the “Low Flow” TGA run is shown in FIG. 11.

The fibers were found not to be losing the residual solvents prior to reaching the imidization temperature. The imidization temperature appeared have shifted to above 250° C., with some limited imidization starting to occur at 250° C. The presence of water, which would have otherwise been removed by a higher flow rate of gases, appeared to retard the imidization process.

TABLE 9
Summary of TGA Weight Losses in the “Low Flow” Run.

| Step | Weight Loss (%) | Potential Source |
|---|---|---|
| RT Hold | 1.2% | Physisorbed H₂O, |
| | | Hexane |
| RT to 150° C. | 1.1% | Physisorbed H₂O, |
| | | Hexane |
| 150° C.Hold | 0.0% | — |
| 150° C.-250° C. | 0.0% | — |
| 250° C. Hold | 0.9% | Imidization (H₂O) |

Using the TGA results, the thermal cycle required to imidize the VTEC 080-051 poly(amic acid) hollow fibers was significantly reduced from 2 days to 15 hours. The importance of maintaining high nitrogen flow rates was also realized. TGA studies helped develop an imidization protocol which was significantly shorter than the baseline protocol developed for flat sheet membrane films. With the studies conducted on small fiber strands, the inventors of the instant application set out to develop an experimental setup which would allow scale-up of the imidization protocol developed using TGA. The effect of curing environment and purge gas flow rates were studied.

Curing Protocol Development

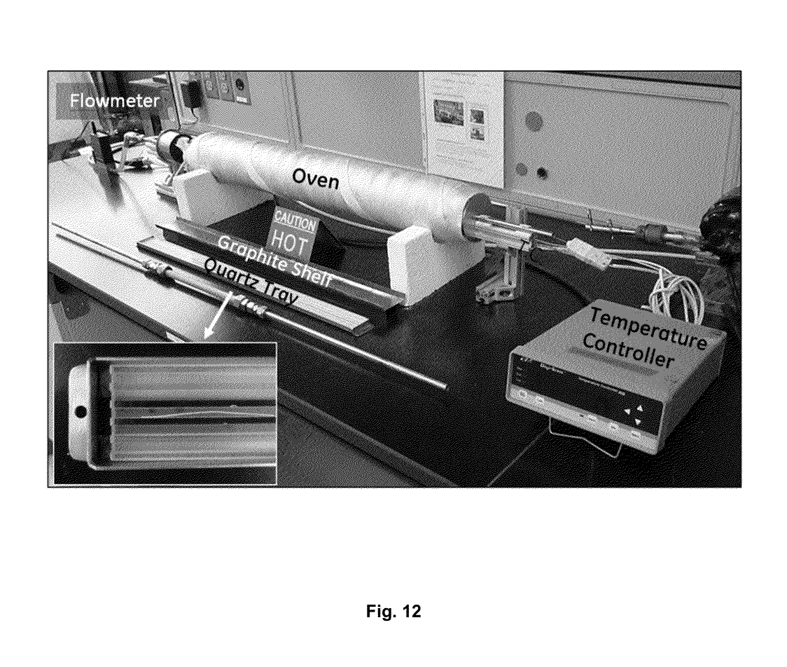

The solvent exchanged polyamic acid hollow fibers were imidized to form a thermally and chemically robust polyimide hollow fiber membrane. Fibers were thermally cured in a custom built oven using the conditions shown in Table 10. FIG. 12 shows the oven used for curing polyimide hollow fibers. A close-up of the quartz tray is shown in detail.

TABLE 10
Curing Profile

| Hold Temperature | Hold Time | |
|---|---|---|
| (° C.) | (hrs) | |
| RT | 0.5 | |
| 100 | 0 | |
| 150 | 6 | |
| 250 | 6 | |
| Temp Ramp Rate | 2° | C./min |
| N₂ Flow Rate | 101 | pm |

A custom built oven shown in Figure was designed and fabricated. The oven consisted of a steel tube wrapped with heating tape (BriskHeat, 1″×96″, 830 W, 120V), and insulating tape (Glaspun, 2″×0.03″×100′). The heating tape was controlled by a Digi-Sense® Temperature Controller R/S with a thermocouple positioned in the middle of the tube within a few millimeters of the fibers. If desired, nitrogen could be fed into the oven and controlled with a flow meter. Fibers were cured on a quartz tray positioned near the middle of the oven. The quartz tray had five 3 mm grooves to place individual fibers.

The effects of temperature and atmosphere on the porosity, surface roughness, and densification of the hollow fibers were studied. Previous experience with polyimide coatings on stainless steel tubes showed that curing the VTEC 080-051 material in stagnant air led to a brittle, cracked polyimide film. It was hypothesized that excessive NMP or water produced during the imidization process was the cause. The cracking problem in the dense films was resolved by flowing gas through the tubes during the curing process. Hollow fibers go through an additional solvent exchange process to remove the NMP solvent prior to curing. However, water is still produced during the imidization process, the removal of which could be aided by a flowing atmosphere. Increasing the flow rate of nitrogen was found to speed up the rate of drying and imidization and to reduce the temperature at which imidization occurred. It was hypothesized that the flowing nitrogen aided in the removal of water during imidization.

As mentioned above, the nitrogen flow rate changed the temperature at which imidization occurred. Fibers were fully imidized when cured for 6 hours at 230° C. to 250° C. with a 3.6 lpm flow rate of nitrogen. However, it was found that temperatures less than 240° C. were insufficient to fully remove residual PVP in the fibers. Therefore, the inventors of the instant application chose 250° C. as the imidization temperature.

Hollow Fiber Module Testing

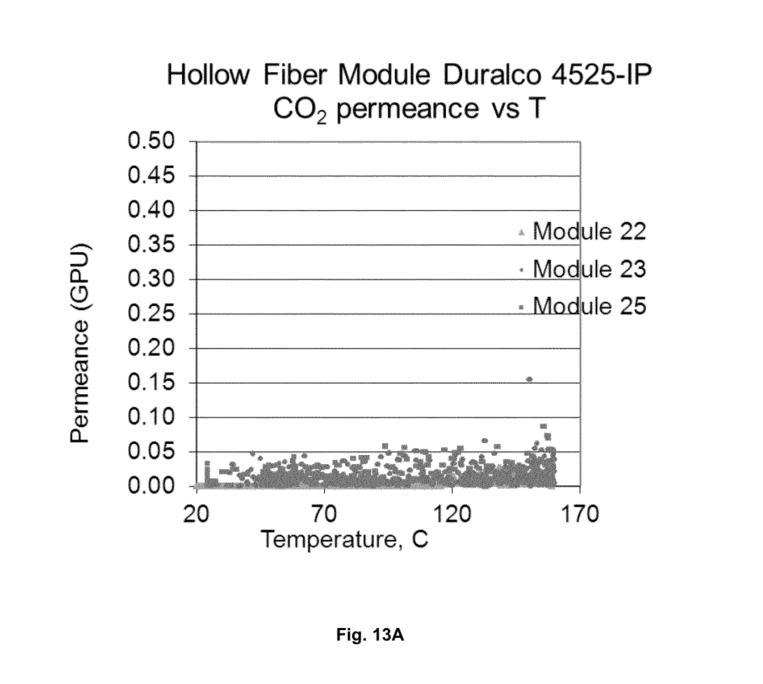

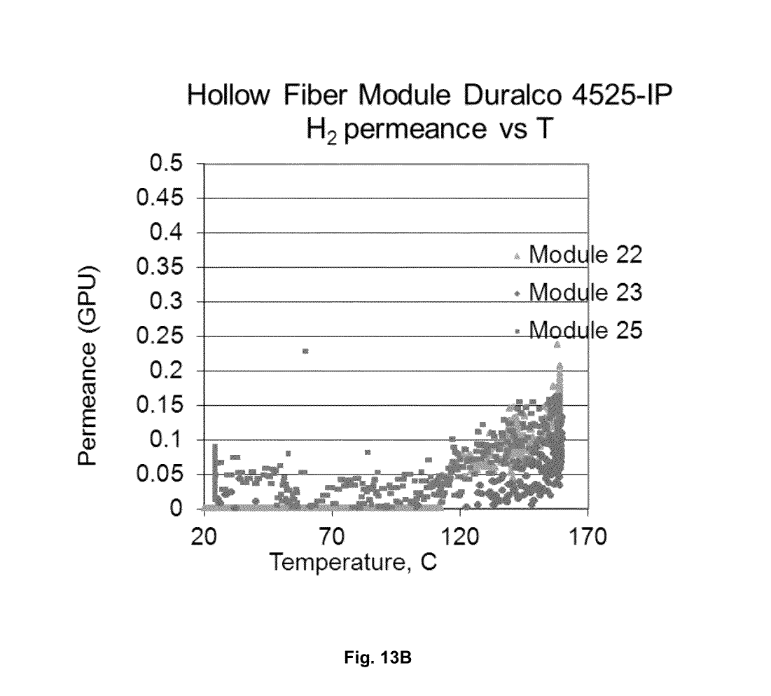

Three modules were assembled with VTEC™ polyimide hollow fibers and heated to 150° C. in ideal syngas (50 vol. % H₂/50 vol. % CO₂) to measure permeance of H₂ and CO₂ and H₂/CO₂ selectivity. All of the modules were heated to 150° C. and cooling back to room temperature without any signs of performance degradation. The H₂/CO₂ selectivity values ranged from 4-15. The H₂ permeance and selectivity of the 3 modules was similar, with H₂ permeance˜0.1 GPU and selectivity˜10 at 150° C. The testing results from the modules are shown in FIG. 13.

The behavior of permeance with temperature was the same for heating and cooling for both H₂ and CO₂, indicating no leaks or changes in the fibers during the heating cycle. The performance from an example module, module 23, is shown below.

TABLE 11
Summary of GE Testing: Hollow Fiber Module 23.
Hollow Fiber Module 23

| | | | Avg values | | |
|---|---|---|---|---|---|
| | Feed | | H2 | CO2 | |
| | pressure, | | permeance | permeance | |
| Temp. C. | psig | Gas | GPU | GPU | H2/CO2 |
| 150 | 4 | H2—CO2 | 0.19 | 0.02 | 8.2 |

H₂/CO₂ Testing Under Coal Syn-Gas

The module was initially heated to 150° C. in pure H₂ and held for 100 hrs. H₂ permeance was 0.35 GPU, which is in good agreement with the simulated mixed gas data. The process gas was then changed to 60.7 vol. % H₂/38.3 vol. % CO₂/0.98 vol. % CO and the module was held for 200 hours. The H₂ permeance did not change, and CO₂ permeance was measured as 0.03 GPU, with H₂/CO₂ of 10. After 200 hours, temperature was increased to 200° C. and held for 200 hours. The H₂/CO₂ selectivity remained stable, and H₂ permeance increased to 0.6 GPU. The results are summarized in

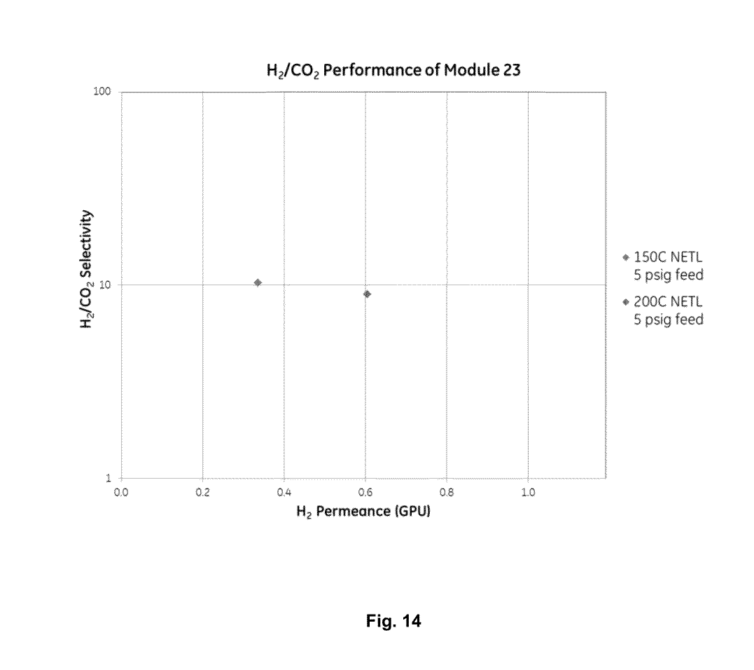

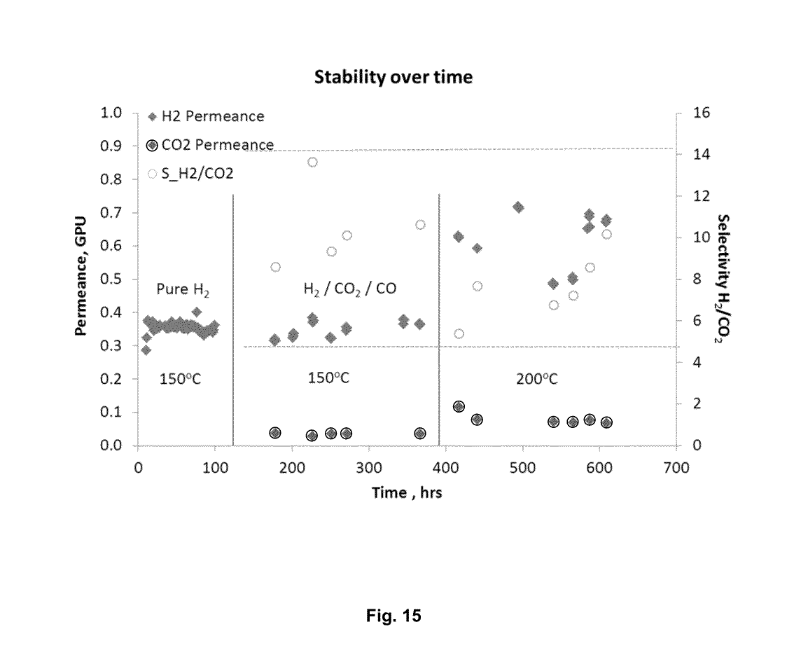

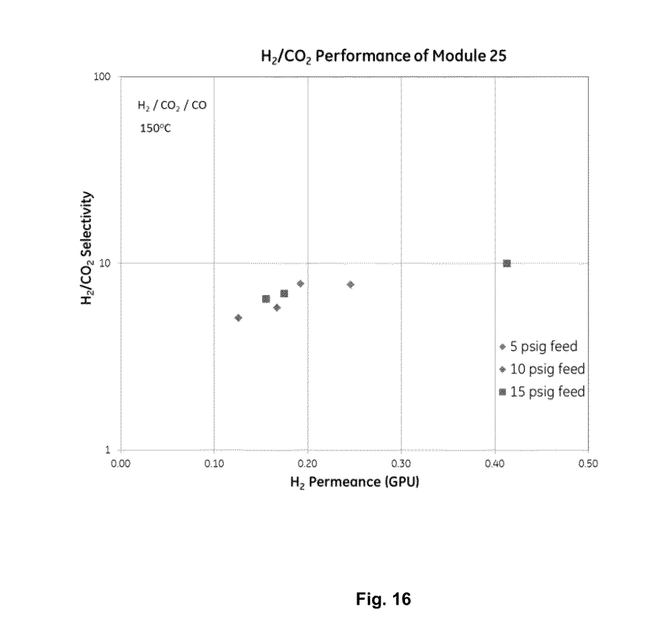

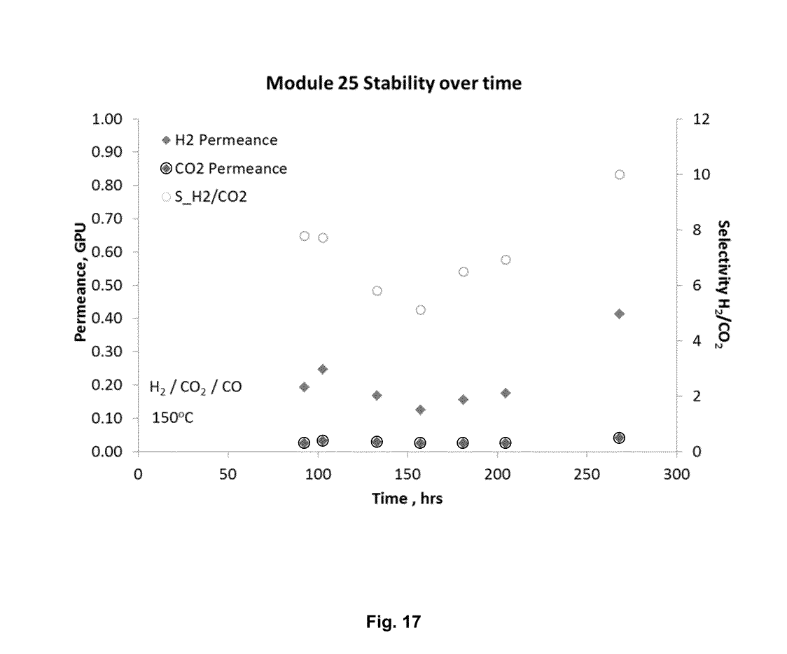

Table 12 (see also FIGS. 14-17).

TABLE 12
Summary of coal syn-gas Testing: Hollow Fiber Module 23.

| Hollow Fiber | | | | | | |
|---|---|---|---|---|---|---|
| Module 23 | | | Average values | | | |
| | | Feed | | H2 | CO2 | |
| | | pressure, | | permeance | permeance | |
| hrs | Temp. C. | psig | Gas | GPU | GPU | H2/CO2 |
| 100 | 150 | 5 | pure H2 | 0.35 | x | x |
| 200 | 150 | 5 | NETL | 0.35 | 0.03 | 10.3 |
| 200 | 200 | 5 | NETL | 0.61 | 0.07 | 9.0 |

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of ordinary skill in the art upon reviewing the above description. The scope of the invention should, therefore, be determined with reference to the appended claims, along with the full scope of equivalents to which such claims are entitled.

In the appended description, the terms “including” and “in which” are used as the plain-English equivalents of the respective terms “comprising” and “wherein.” Moreover, in the following claims, the terms “first,” “second,” etc. if any, are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable any person of ordinary skill in the art to practice the embodiments of invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the disclosure may include only some of the described embodiments. Accordingly, the invention is not to be seen as limited by the foregoing description, but is only limited by the scope of the appended claims.

1. A membrane for gas separation, comprising asymmetric hollow polyimide fibers derived from a precursor composition comprising polyamic acid and an additive, wherein said membrane is a heat resistant membrane and is operable up to about 350° C.

2. The membrane of claim 1, wherein the membrane is operable from about 20 to about 350° C.

3. The membrane of claim 1, wherein the membrane is also resistant to chemical degradation, such that the membrane is resistant to changes in its structure and membrane function as a result of treatment with mercury, steam, hydrogen sulfide, carbon monoxide, fly-ash, SOx, NOx, acid gases.

4. The membrane of claim 1, wherein said additive is a material capable of increasing hydrophilic character of the polyimide fibers.

5. The membrane of claim 4, wherein the additive is selected from a group consisting of polyvinylpyrrolidone, polyetheretherketones, lithium nitrate, poly(ethylene glycol) (PEG), lithium chloride (LiCl), acetic acid, phosphoric acid, and propionic acid.

6. The membrane of claim 1, wherein the precursor composition comprises about 5 to 50 weight percent solution of poly(amic acid) in a solvent.

7. The membrane of claim 1, wherein said polyamic acid is obtained by reacting a dianhydride monomer with a diamine monomer, and wherein the composition further comprises n-methyl-2-pyrrolidone (NMP).

8. The membrane of claim 7, wherein said dianhydride monomer is (diphenyltetracarboxylic dianhydride (ODPA) and the said diamine monomer is oxy-dianiline (ODA)).

9. The membrane of claim 1, wherein said membrane exhibits gas separation performance in which the permselectivity for hydrogen/carbon dioxide is from about 5 to 10, the hydrogen/carbon monoxide permselectivity is from about 30 to 60, the permselectivity for water/hydrogen is from about 5 to 10, and a carbon dioxide/methane permselectivity is from about 5 to 20.

10. The membrane of claim 1, wherein the membrane is used for hydrogen purifications at high temperatures of from about room temperature to about 350° C.

11. The membrane of claim 1, wherein the hollow asymmetric membrane is made from a one step extrusion of a polyamic acid spinning solution comprising polyamic acid, solvent, non-solvent, and an additive.

12. A method for the production of an asymmetric hollow fiber membrane comprising: a) preparing a dope solution comprising a poly(amic acid), a non-solvent, and one or more of solvents selected from the group consisting of NMP, N,N-dimethylacetamide, and N,N-dimethylformamide, and tetrahydro furan; b) dissolving an additive in said dope solution to form a viscous dope mixture; and c) spinning said dope mixture to form a polyimide-based asymmetric hollow fiber membrane.

13. The method of claim 12, wherein said polyimide is obtained by curing a polyamic acid, and wherein the said polyamic acid is obtained by reacting a dianhydride monomer with a diamine monomer.

14. The method of claim 12, wherein said additive is selected from a group consisting of polyvinylpyrrolidone, polyetheretherketones, lithium nitrate, poly(ethylene glycol) (PEG), lithium chloride (LiCl), acetic acid, phosphoric acid, and propionic acid.

15. The method of claim 12, wherein the non-solvent is selected from the group consisting of water, methanol, ethanol, n-propanol, isopropanol, acetone, ethylene glycol, glycerol, priopionic acid, methyl ethyl ketone, diethyl ketone, ethyl propyl ketone, or mixtures thereof.

16. The method of claim 12, wherein the additive is polyvinylpyrrolidone and the non-solvent is water or ethanol.

17. The method of claim 12, wherein after the spin dope is mixed with the additive, the spin dope is heated to no more than about 80° C. to achieve the desired dope uniformity and additive dissolution.

18. The method of claim 12, further comprising an extrusion step wherein a coagulation liquid into which the dope solution is extruded during membrane formation is selected from the group consisting of water, and an aqueous solution of ethanol, methanol, hexane, C1-C6 hydrocarbons, glycol, glycerol, acetic acid, propionic acid and mixture thereof.

19. The method of claim 12, wherein the method further comprises subjecting the dope mixture to a solvent exchange step, followed by imidizing or curing.

20. A method of selectively separating and recovering at least one kind of gas from a mixed gas or vapor, comprising feeding the mixed gas or vapor to a feed side of a gas separation membrane comprising the asymmetric hollow membrane made of claim 1, and selectively passing the at least one kind of gas or vapor of the mixed gas or vapor through the gas separation membrane to a permeate side of the gas separation membrane.

21. The method of claim 20, wherein said membrane exhibits gas separation performance in which the permselectivity for hydrogen/carbon dioxide is from about 5 to 10, the hydrogen/carbon monoxide permselectivity is from about 30 to 60, the permselectivity for water/hydrogen is from about 5 to 10, and a carbon dioxide/methane permselectivity is from about 5 to 20.

22. The method of claim 20, wherein the membrane is used in high purity hydrogen production, carbon capture, chemical manufacturing, power generation, refinery application, Fischer Tropsch liquids, fuel cell applications, and water/organic separations.

23. The method of claim 20, wherein the membrane is used to separate a variety of gases or vapors, including steam, hydrogen gas, steam, carbon dioxide, oxygen gas, nitrogen gas, methane, C1-C4 hydrocarbons, heavier hydrocarbons, carbon monoxide, hydrogen sulfide and hot mixed gases or vapors that contain organic compound.

24. A method for selectively separating and recovering a particular gas from a mixed gas containing two or more gases or vapors, said method comprising passing said gas through a membrane comprising asymmetric hollow polyimide fibers derived from a precursor composition comprising polyamic acid and an additive.

25. A method for selectively separating and recovering a particular gas from a mixed gas containing two or more gases or vapors, said method comprising passing said gas through a membrane made by the process according to claim 12.

26. The method of claim 25, wherein said membrane exhibits gas separation performance in which the permselectivity for hydrogen/carbon dioxide is from about 5 to 10, the hydrogen/carbon monoxide permselectivity is from about 30 to 60, the permselectivity for water/hydrogen is from about 5 to 10, and a carbon dioxide/methane permselectivity is from about 5 to 20.

27. The method of claim 25, wherein said method is carried out at a temperature in the range of about 150° C. to about 350° C.
